(19) United States
(12) Patent Application Publication
(10) Pub. No.: US 2025/0141670 A1
(43) Pub. Date: May 1, 2025

(54) METHOD, APPARATUS, SYSTEM, AND COMPUTER PROGRAM FOR AUTOMATIC PQC MIGRATION FOR APPLICATION

(71) Applicant: SAMSUNG SDS CO., LTD., Seoul (KR)

(72) Inventors: Hunhee YU, Seoul (KR); Jonghyun CHOI, Seoul (KR); Jinhyuck JEONG, Seoul (KR); Jihoon CHO, Seoul (KR)

(73) Assignee: SAMSUNG SDS CO., LTD., Seoul (KR)

(21) Appl. No.: 18/917,897

(22) Filed: Oct. 16, 2024

(30) Foreign Application Priority Data
Oct. 30, 2023 (KR) 10-2023-0147077

(51) Int. Cl. H04L 9/08; H04L 9/40

(52) U.S. Cl. CPC H04L 9/0852; H04L 63/1433

(57) ABSTRACT

The present disclosure relates to a method, a device, a system, and a computer program for automatically performing PQC migration on an application, and more specifically, the present disclosure discloses a method for automatically performing PQC migration on an application using a computing device, the method including: determining whether or not a first application has quantum vulnerability on the basis of information about the first application, which is collected from an application distribution server configured to distribute source code of an application; modifying one or more of source code, settings, or environment variables for the first application, based on a result of the determination, by the application distribution server; and generating an execution file for the first application by reflecting the modified source code, settings, or environment variables.

### CROSS-REFERENCE TO RELATED APPLICATION(S)

This application is based on and claims priority under 35 U.S.C. 119 to Korean Patent Application No. 10-2023-0147077, filed on Oct. 30, 2023, in the Korean Intellectual Property Office, the disclosure of which is herein incorporated by reference in its entirety.

### BACKGROUND OF THE INVENTION

### 1. Field of the Invention

The present disclosure relates to a method, an apparatus, a system, and a computer program for automatically performing PQC migration on applications and, more specifically, it relates to a method, an apparatus, a system, and a computer program for automatically performing PQC migration on applications capable of checking whether an application distributed through a server or the like has quantum vulnerability and automatically generating an application with improved quantum vulnerability by applying an appropriate post-quantum cryptography algorithm.

### 2. Description of the Prior Art

As various services are provided based on wired and wireless communication networks these days, the importance of security is continuously increasing, and accordingly, various security algorithms are being developed and applied.

However, there are inevitable limitations as to manpower and resources available to administrators or the like to perform security management for applications for providing services or the like, so various security risks for multiple applications must be effectively resolved using limited resources.

Furthermore, with the recent development of quantum computing technology, the risk that existing encryption systems may be disabled based on this is being realized, and accordingly, a method to respond to the security risks by applying post-quantum cryptography (PQC) technology is being proposed.

In this regard, as shown in FIG. 1, in the past, in order to perform PQC migration on a given application, an administrator or the like had to directly analyze the quantum vulnerability of the application, set the necessary environment variables or the like while changing the post-quantum cryptography library for the application on the basis of the results, and further, modify a docker file and perform building thereof to generate a docker container image in order to distribute the docker container image. This was difficult because the administrator must manually perform a series of processes of generating and distributing the docker container image.

As a result, there was a problem that a lot of resources such as manpower and time must be provided to respond to quantum vulnerability risks for various applications, and there was also a risk that applications with unimproved quantum vulnerability would be distributed due to the inexperience or carelessness of the operator.

Accordingly, there is a need for a method capable of efficiently responding to the quantum vulnerability risks for various applications while minimizing the required resources and effectively avoiding quantum vulnerability in applications, which may be caused by operator errors, but an appropriate solution thereto has not yet been presented.

### SUMMARY OF THE INVENTION

The present disclosure has been made to solve the above-described problems in the prior art and aims to provide a method, an apparatus, a system, and a computer program for automatically performing PQC migration on an application, which can efficiently respond to quantum vulnerability risks for various applications while minimizing the required resources.

In addition, the present disclosure aims to provide a method, an apparatus, a system, and a computer program for automatically performing PQC migration on an application, which can effectively prevent quantum vulnerability in an application that may be caused by operator errors.

The technical problems to be solved in the present disclosure are not limited to the technical problems mentioned above, and other technical problems that are not mentioned would be clearly understood by those skilled in the art to which the present disclosure belongs from the description in this specification.

According to one aspect of the present disclosure, a method for automatically performing PQC migration on an application using a computing device may include: determining whether or not a first application has quantum vulnerability on the basis of information about the first application, which is collected from an application distribution server configured to distribute source code of an application; modifying one or more of source code, settings, or environment variables for the first application, based on a result of the determination, by the application distribution server; and generating an execution file for the first application by reflecting the modified source code, settings, or environment variables.

Here, the determining may include determining whether or not the first application has quantum vulnerability using a predefined rule set on the basis of version information of the first application.

In addition, if the rule set does not include information on quantum vulnerability corresponding to the version information of the first application, it may be determined whether or not the first application has quantum vulnerability using the source code of the first application.

In addition, the rule set may be updated on the basis of a result of determining whether or not the first application has quantum vulnerability using the source code of the first application.

In addition, the modifying may include: producing a first post-quantum cryptography library corresponding to the version information of the first application using the rule set; and modifying one or more of the source code, settings, or environment variables for the first application such that a cryptographic algorithm of the first post-quantum cryptography library is further reflected in addition to a cryptographic algorithm currently being used in the first application.

In addition, the generating may include generating a docker container image to be executed on the basis of a cloud for the first application.

In this case, the modifying may include modifying a docker file for the first application on the basis of the modified source code, settings, or environment variables.

In addition, the computing device may be configured to perform PQC migration on the first application that is produced or updated and distributed by a third party.

According to another aspect of the present disclosure, a server may include a processor and a memory, and may be configured to automatically perform PQC migration on an application, wherein the memory may include instructions configured to cause, when executed by the processor, the server to implement specific operations, and the specific operations may include: determining whether or not a first application has quantum vulnerability on the basis of information about the first application, which is collected from an application distribution server configured to distribute source code of an application; modifying one or more of source code, settings, or environment variables for the first application, based on a result of the determination, by the application distribution server; and generating an execution file for the first application by reflecting the modified source code, settings, or environment variables.

Here, the determining may include determining whether or not the first application has quantum vulnerability using a predefined rule set on the basis of version information of the first application.

In addition, if the rule set does not include information on quantum vulnerability corresponding to the version information of the first application, it may be determined whether or not the first application has quantum vulnerability using the source code of the first application.

In addition, the rule set may be updated on the basis of a result of determining whether or not the first application has quantum vulnerability using the source code of the first application.

In addition, the modifying may include: producing a first post-quantum cryptography library corresponding to the version information of the first application using the rule set; and modifying one or more of the source code, settings, or environment variables for the first application such that a cryptographic algorithm of the first post-quantum cryptography library is further reflected in addition to a cryptographic algorithm currently being used in the first application.

In addition, the generating may include generating a docker container image to be executed on the basis of a cloud for the first application.

In this case, the modifying may include modifying a docker file for the first application on the basis of the modified source code, settings, or environment variables.

In addition, the server may perform PQC migration on the first application that is produced or updated and distributed by a third party.

According to another aspect of the present disclosure, a computer-readable storage medium may store instructions configured to cause, when executed by a processor, a server, which includes the processor and automatically performs PQC migration on an application, to implement specific operations, and the specific operations may include: determining whether or not a first application has quantum vulnerability on the basis of information about the first application, which is collected from an application distribution server configured to distribute source code of an application; modifying one or more of source code, settings, or environment variables for the first application, based on a result of the determination, by the application distribution server; and generating an execution file for the first application by reflecting the modified source code, settings, or environment variables.

Accordingly, in a method, an apparatus, a system, and a computer program for automatically performing PQC migration on an application according to an embodiment of the present disclosure, it is possible to efficiently respond to quantum vulnerability risks for various applications while minimizing the required resources.

In addition, in a method, an apparatus, a system, and a computer program for automatically performing PQC migration on an application according to an embodiment of the present disclosure, it is possible to effectively prevent quantum vulnerability in an application, which may be caused by operator errors.

The effects obtainable from the present disclosure are not limited to the effects mentioned above, and other effects that are not mentioned would be clearly understood by those skilled in the art to which the present disclosure belongs from the description in this specification.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a drawing illustrating a PQC migration operation for an application according to the prior art.

FIG. 2 is a drawing illustrating the configuration of an automatic PQC migration execution system according to an embodiment of the present disclosure.

FIG. 3 is a flowchart illustrating an automatic PQC migration execution method according to an embodiment of the present disclosure.

FIG. 4 is a drawing illustrating the configuration and operation of an automatic PQC migration execution system according to an embodiment of the present disclosure.

FIG. 5 is a specific flowchart illustrating a modifying step in an automatic PQC migration execution method according to an embodiment of the present disclosure.

FIGS. 6 to 8, 9A and 9B are drawings illustrating specific examples of an automatic PQC migration execution method according to an embodiment of the present disclosure.

FIG. 10 is a specific flowchart of an automatic PQC migration execution method according to an embodiment of the present disclosure.

FIG. 11 is a drawing illustrating the configuration of a computing device that automatically performs PQC migration according to an embodiment of the present disclosure.

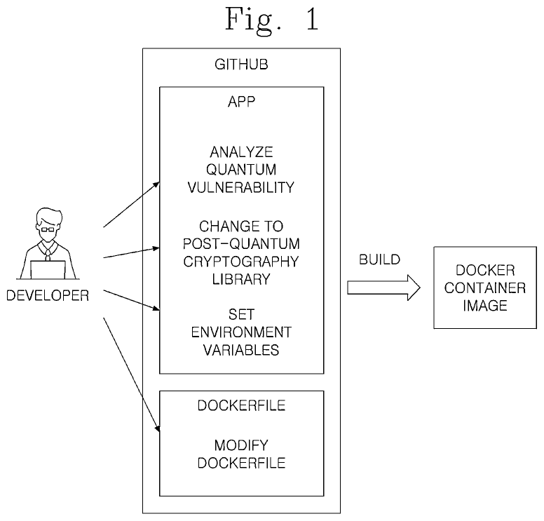

### DETAILED DESCRIPTION OF THE EXEMPLARY EMBODIMENTS

Hereinafter, the embodiments disclosed in the present disclosure will be described in detail with reference to the attached drawings. The purpose, specific advantages, and novel features of the present disclosure will become more apparent from the following detailed description and preferred embodiments associated with the attached drawings.

Prior to the description, it should be noted that the terms or words used in the specification and the appended claims are represented to appropriately define concepts by the inventor in order to explain the invention in the best way, and thus should be interpreted to have meanings and concepts consistent with the technical idea of the present disclosure, instead of being interpreted to limit the present disclosure.

When assigning reference numerals to components, identical or similar components will be assigned the same reference numerals, and redundant descriptions thereof will be omitted. The term “module” and “unit” used in the following description for components are assigned or used interchangeably in consideration of the ease of drafting the specification, and do not have distinct meanings or roles themselves, and may indicate software or hardware components.

In describing the components of the present disclosure, a component expressed in a singular form should be understood to encompass a plurality of components unless specifically stated otherwise. In addition, the terms “first”, “second”, and the like are used to distinguish one component from another component, and the components are not limited to the terms. In addition, the configuration in which a component is connected to another component indicates that another component may be provided between the two components.

In addition, when describing the embodiments disclosed in this specification, a specific description of a related known technology, which may obscure the gist of the embodiments disclosed in this specification, will be omitted. In addition, it should be understood that the attached drawings are only intended to facilitate understanding of the embodiments disclosed in this specification, and that the technical idea disclosed in this specification is not limited to the attached drawings and encompasses all modifications, equivalents, or substitutes included in the scope of the present disclosure.

Hereinafter, embodiments of a method, an apparatus, a system, and a computer program for automatically performing PQC migration on an application according to the present disclosure will be described in detail with reference to the attached drawings.

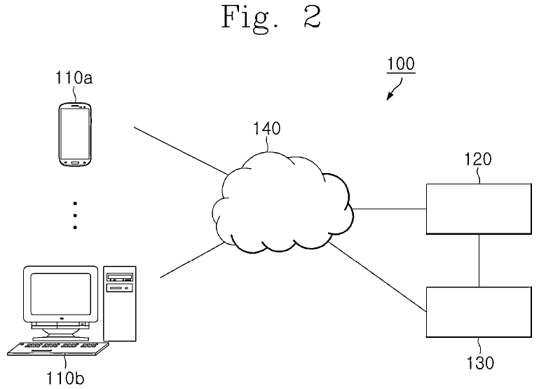

FIG. 2 illustrates the configuration and operation of a PQC migration system 100 according to an embodiment of the present disclosure. As shown in FIG. 2, the PQC migration system 100 according to an embodiment of the present disclosure may be configured to include an application distribution server 120 that distributes source code or the like of an application to one or more devices 110, and a PQC migration server 130 that identifies quantum vulnerability for an application distributed by the application distribution server 120 and automatically performs PQC migration by applying post-quantum cryptography (PQC).

In this case, various terminals such as personal computers (PCs), laptop PCs, tablet PCs, smartphones, PDAs, and the like, which may receive and use the distributed application, may be used as the device 110, but the present disclosure is not necessarily limited thereto, and various devices such as a server, which receives and uses applications provided from the application distribution server 120, may be used as the device 110.

In addition, the application distribution server 120 may be implemented using one or more physical servers, but the present disclosure is not necessarily limited thereto, and in addition, it may be configured using personal computer processing devices such as desktop computers, laptops, tablets, smartphones, or the like, configured based on a cloud system, or implemented in various forms such as a dedicated device.

In addition, although the PQC migration server 130 may also be implemented using one or more physical servers, it may be further implemented using a cloud system or a dedicated device, and in addition, it may be implemented in a form in which the application distribution server 120 and the PQC migration server 130 are integrated to one server.

In addition, as a network 140 connecting the one or more devices 110, the application distribution server 120 and the PQC migration server 130 in FIG. 2, a wired network and a wireless network may be used, and specifically, it may include various communication networks such as a local area network (LAN), a metropolitan area network (MAN), and a wide area network (WAN). In addition, the network 140 may include the well-known World Wide Web (WWW). In addition, the network 140 may be implemented using a data bus configured to transmit and receive data or the like.

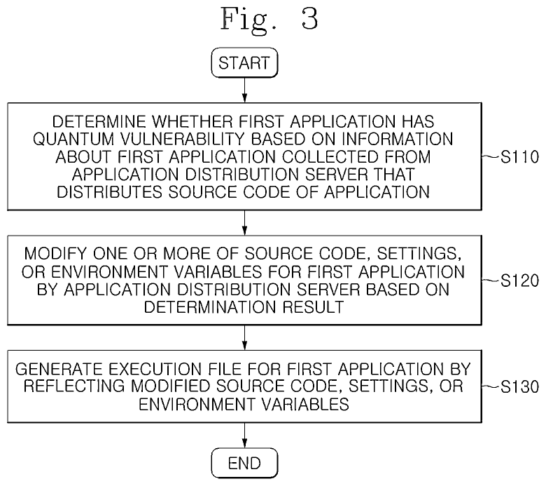

In addition, FIG. 3 illustrates an automatic PQC migration execution method according to an embodiment of the present disclosure.

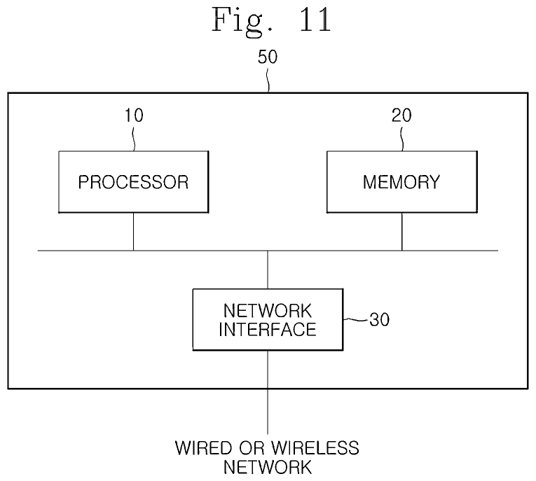

Here, the method illustrated in FIG. 3 may be performed, for example, by the PQC migration server 130, and the PQC migration server 130 may be implemented to include a computing device 50, which will be described later with reference to FIG. 11. For example, the PQC migration server 130 may include a processor 10, and the processor 10 may execute instructions configured to perform operations for automatically performing PQC migration on an application.

More specifically, as shown in FIG. 3, the automatic PQC migration execution method according to an embodiment of the present disclosure is a method of automatically performing PQC migration on an application using a computing device 50, and may include a step S110 of determining whether or not a first application has quantum vulnerability on the basis of information about the first application collected from the application distribution server 120 that distributes the source code of the application, a step S120 of modifying one or more of the source code, settings, or environment variables for the first application by the application distribution server 120 on the basis of a result of the determination, and a step S130 of generating an execution file 300 for the first application by reflecting the modified source code, settings, or environment variables.

Here, in the determining step S110, it may be determined whether or not the first application has quantum vulnerability using a predefined rule set 220 on the basis of version information of the first application.

In addition, if the rule set 220 does not include information about determining the quantum vulnerability corresponding to the version information of the first application, it may be determined whether or not the first application has quantum vulnerability using the source code 121 for the first application.

In addition, the rule set 220 may be updated on the basis of a result of determining whether or not the first application has quantum vulnerability using the source code 121 for the first application.

In addition, the modifying step S120 may include a step S121 of producing a first post-quantum cryptography library corresponding to the version information of the first application using the rule set 220, and a step S122 of modifying one or more of the source code, settings, or environment variables for the first application so that the cryptographic algorithm of the first post-quantum cryptography library is further reflected in addition to the cryptographic algorithm currently being used in the first application.

In addition, in the generating step S130, a docker container image that is performed based on a cloud for the first application may be generated.

In this case, in the modifying step S120, the docker file for the first application may be modified based on the modified source code, settings, or environment variables.

In addition, the computing device 50 may perform PQC migration on the first application that is produced or updated and distributed by a third party.

Accordingly, in the method, apparatus, system, and computer program for automatically performing PQC migration on an application according to an embodiment of the present disclosure, it is possible to efficiently respond to quantum vulnerability risks for various applications while minimizing required resources, and to effectively prevent quantum vulnerability in an application, which may be caused by operator errors.

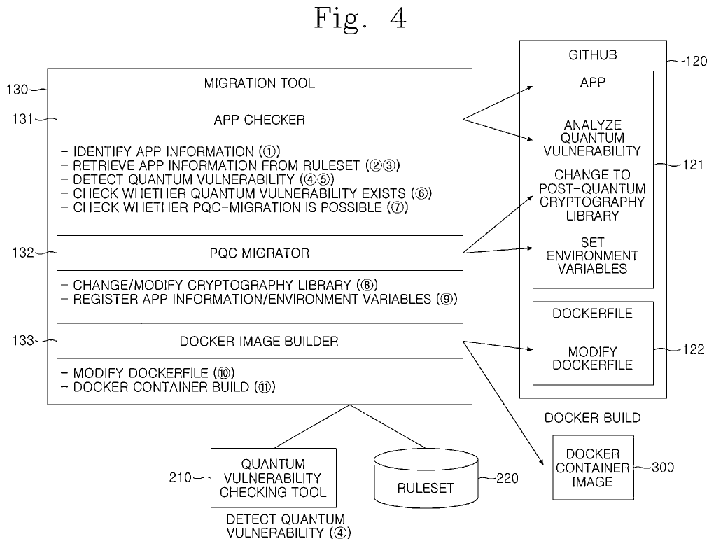

In addition, FIG. 4 illustrates a specific configuration and operation of a PQC migration system 100 according to an embodiment of the present disclosure.

Hereinafter, the configuration and operation of the PQC migration system 100 according to an embodiment of the present disclosure will be described in more detail with reference to FIGS. 2 to 4.

First, in step S110, the computing device 50 determines whether or not the first application has quantum vulnerability on the basis of information about the first application collected from the application distribution server 120 that distributes the source code of the application.

In this case, although the computing device 50 may be the PQC migration server 130, the present disclosure is not necessarily limited thereto, and may be implemented in various forms, such as a single server implemented by combining the PQC migration server 130 and the application distribution server 120.

In addition, the application distribution server 120 may be a server that distributes the application, as well as the source code for the application or the like.

For a more specific example, as shown in FIG. 4, the application distribution server 120 may be a platform that distributes source code of various applications such as Github or provides an environment for collaboration between multiple developers to modify the source code of the applications or the like, but the present disclosure is not necessarily limited thereto.

Accordingly, as shown in FIG. 4, in step S110, the computing device 50, such as the PQC migration server 130, may determine whether or not the first application has quantum vulnerability on the basis of version information of the first application on which PQC migration is to be performed, which is received from the application distribution server 120 (\textcircled{1} in FIG. 4).

For a more specific example, in the case where the PQC migration server 130 identifies whether or not Nginx v1.23.3, which is the open-source web server software distributed by the application distribution server 120, has quantum vulnerability and performs PQC migration, the PQC migration server 130 may check, based on the version information (e.g., v1.23.3) of the first application (Nginx), whether or not post-quantum cryptography or the like has been applied to the above version of first application (Nginx v1.23.3) to determine the quantum vulnerability, identify a post-quantum cryptography library (e.g., PQC-OpenSSL 1.1.1) applicable to the above version of first application (Nginx v1.23.3) according to the determination result, and reflect the same in the source code of the above version of first application (Nginx v1.23.3).

Accordingly, in step S110, the PQC migration server 130 may determine whether or not the first application has quantum vulnerability using a predefined rule set 220 on the basis of the version information for the first application.

In this case, the rule set 220 may include information about whether there is quantum vulnerability for various versions of various applications, information about whether PQC migration is possible, information about applicable post-quantum cryptography libraries, information for modifying source code, settings, or environment variables of the application, or the like.

More specifically, the PQC migration server 130 retrieves version information of the first application from the rule set 220 (\textcircled{2} in FIG. 4) and determines whether or not there is information about the above version of first application in the rule set 220 (\textcircled{3} in FIG. 4).

Accordingly, if there is information about a specific version of first application in the rule set 220, the PQC migration server 130 may determine whether or not the first application has quantum vulnerability using the rule set 220.

On the other hand, if there is no information about a specific version of first application in the rule set 220, the PQC migration server 130 may determine whether or not the first application has quantum vulnerability using the source code for the first application by driving a separate quantum vulnerability detection tool 210 (\textcircled{4} in FIG. 4), and the PQC migration server 130 may also perform an update on the rule set 220 on the basis of a result of determining whether or not the first application has quantum vulnerability using the quantum vulnerability detection tool 210 (\textcircled{5} in FIG. 4).

Accordingly, the PQC migration server 130 may determine whether or not the first application has quantum vulnerability using the rule set 220 or the quantum vulnerability detection tool 210 (\textcircled{6} in FIG. 4) and also determine whether or not PQC migration is possible for the first application (\textcircled{7} in FIG. 4).

Subsequently, in step S120, based on the determination result by the computing device 50 such as the PQC migration server 130 in step S110, the application distribution server 120 modifies one or more of the source code, settings, or environment variables for the first application.

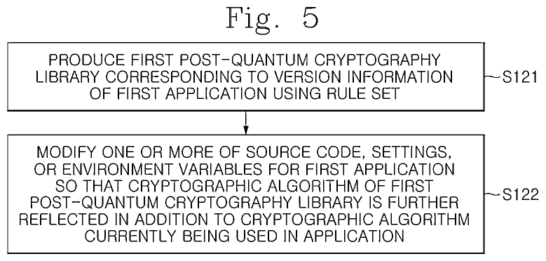

Here, as shown in FIG. 5, step S120 may include a step S121 of producing a first post-quantum cryptography library corresponding to the version information of the first application using the rule set 220 and a step S122 of modifying one or more of the source code, settings, or environment variables for the first application so that the cryptographic algorithm of the first post-quantum cryptography library is further reflected in addition to the cryptographic algorithm currently being used in the first application.

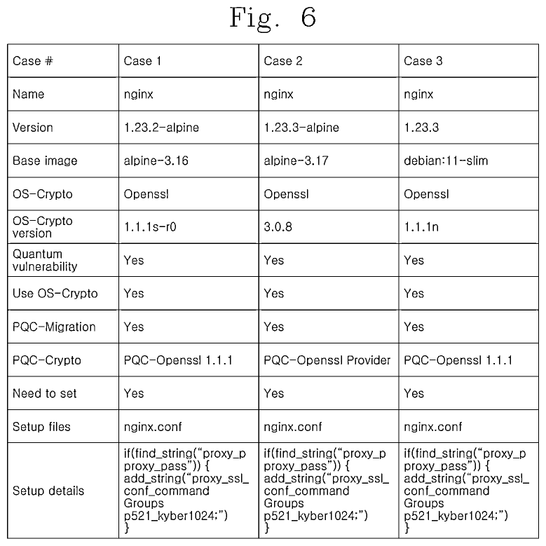

For a more specific example, referring to FIG. 6, Case 1 illustrates a rule set 220 for Nginx v1.23.2-alpine.

In this case, in step S110 above, it may be determined whether or not the first application has quantum vulnerability or the like, on the basis of version information (Version) of Nginx, base image information Base image, operating system-encryption version information OS-Crypto version, or the like. Subsequently, in step S120, if it is determined that the first application has quantum vulnerability in step S110, one or more of the source code, settings, or environment variables for the first application may be modified using the rule set 220.

For a more specific example, the computing device 50 such as the PQC migration server 130 may preferentially produce the first post-quantum cryptography library corresponding to the version information of the first application using the rule set 220 (e.g., in Case 1 in FIG. 6, PQC-OpenSSL 1.1.1 corresponding to Nginx v1.23.2-alpine is produced).

Next, the computing device 50 such as the PQC migration server 130 may modify one or more of the source code, settings, or environment variables for the first application so that the cryptographic algorithm of the first post-quantum cryptography library is further reflected in addition to the cryptographic algorithm currently used in the first application (e.g., in Case 1 in FIG. 6, the phrase of Setup details is further modified for the settings file (nginx.conf) of the engine x) (\textcircled{8} and \textcircled{9} in FIG. 4).

Similarly, in Case 2 and Case 3 in FIG. 6, which also exhibit quantum vulnerability, the post-quantum cryptography library corresponding to each version may be produce on the basis of the rule set 220, and one or more of the source code, settings, or environment variables for each version of application may be modified, thereby automatically performing PQC migration.

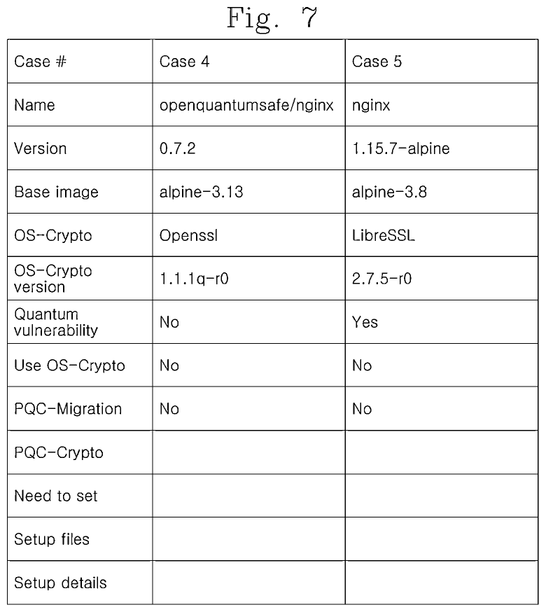

On the other hand, Case 4 in FIG. 7 may be confirmed such that the application has no quantum vulnerability on the basis of the rule set 220, and Case 5 is determined such that the application has quantum vulnerability or PQC migration is impossible on the basis of the rule set 220, thereby requiring additional response.

Accordingly, in step S120 above, the quantum vulnerability for the first application may be resolved by modifying one or more of the source code, settings, or environment variables for the first application, thereby function using the cryptographic algorithm of the first post-quantum cryptography library in addition to the cryptographic algorithm currently being used in the first application.

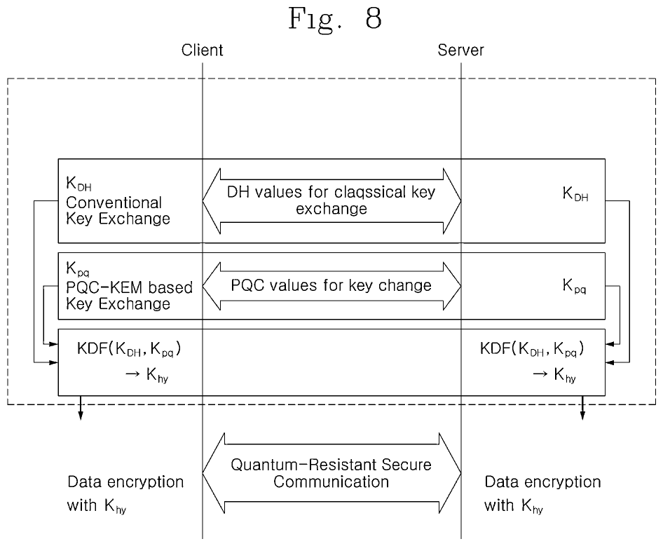

For a more specific example, as shown in FIG. 8, in the first application, the common secret key settings using the public key encryption currently being used and the additional common secret key using the key exchange algorithm of post-quantum cryptography (PQC) are dually set, so that PQC migration may be automatically performed efficiently while minimizing modifications to the first application.

Subsequently, in step S130, the computing device 50 such as the PQC migration server 130 reflects the source code, settings, or environment variables modified in step S120 to generate an execution file for the first application.

In this case, as shown in FIG. 4, in step S130, a docker container image, which is executed based on the cloud for the first application, may be generated as an execution file 300.

To this end, in step S120, a docker file Docker for the first application may be modified on the basis of the modified source code, settings or environment variables (\textcircled{10} in FIG. 4).

Accordingly, in step S130, the computing device 50 such as the PQC migration server 130 may generate a docker container image for the first application on the basis of the modified docker file Docker for the first application (\textcircled{11} in FIG. 4).

In addition, the computing device 50 such as the PQC migration server 130 may generate a docker container image Docker container image for the first application on the basis of the modified docker file Docker for the first application using the application distribution server 120 or another server.

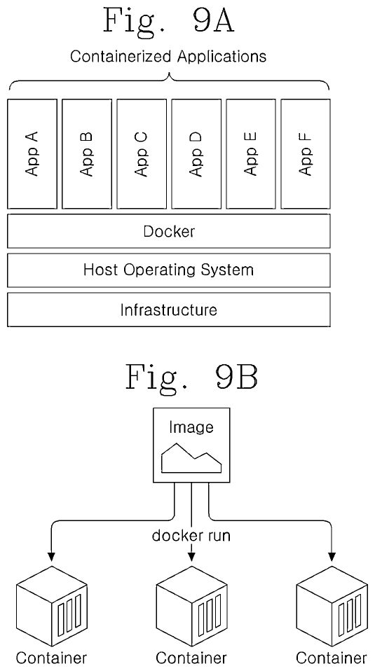

Accordingly, as shown in FIGS. 9A and 9B, the docker container image generated in step S130 may be distributed so as to be efficiently performed in various environments based on the cloud.

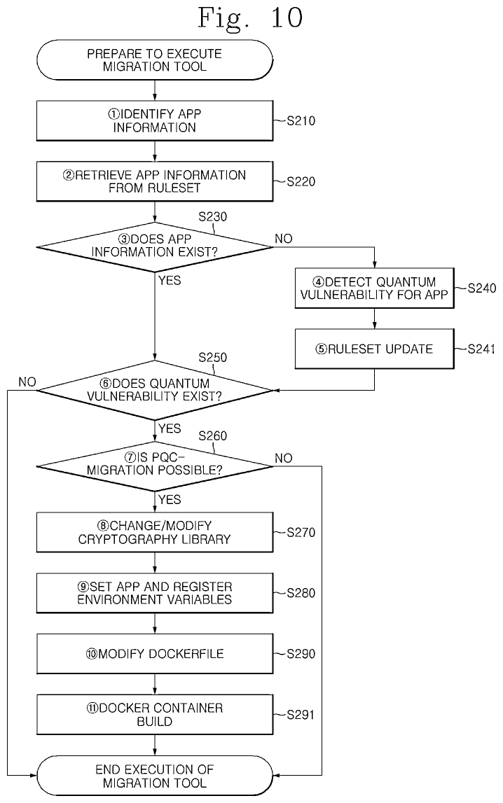

In this regard, FIG. 10 illustrates a specific flowchart of an automatic PQC migration execution method according to an embodiment of the present disclosure.

As shown in FIG. 10, first, in step S210, the PQC migration server 130 checks version information for the first application from the application distribution server 120 (\textcircled{1} in FIG. 10).

Next, the PQC migration server 130 retrieves the version information for the first application from the rule set 220 in step S220 (\textcircled{2} in FIG. 10) and determines whether or not information for the above version of first application exists in the rule set 220 in step S230 (\textcircled{3} in FIG. 10).

In this case, if there is no information for the specific version of first application in the rule set 220, the PQC migration server 130 operates a separate quantum vulnerability detection tool 210 to detect quantum vulnerability for the first application in step S240 (\textcircled{4} in FIG. 10) and updates the rule set 220 with whether or not the first application has quantum vulnerability, which is identified using the quantum vulnerability detection tool 210, and related information in step S241 (\textcircled{5} in FIG. 10).

Accordingly, the PQC migration server 130 determines whether or not the first application has quantum vulnerability using the rule set 220 or the like in step S250 (\textcircled{6} in FIG. 10) and also determines whether or not PQC migration on the first application is possible in step S260 (\textcircled{7} in FIG. 10).

Next, in step S270, the PQC migration server 130 modifies one or more of the source code, settings, or environment variables for the first application such that the cryptographic algorithm of the first post-quantum cryptography library is further reflected in addition to the cryptographic algorithm currently being used in the first application (\textcircled{8} and \textcircled{9} in FIG. 10).

Furthermore, the PQC migration server 130 may modify the docker file Docker for the first application on the basis of the modified source code, settings, or environment variables in step S290 (\textcircled{10} in FIG. 10) and generate a docker container image for the first application on the basis of the modified docker file Docker for the first application in step S291 (\textcircled{11} in FIG. 10).

In addition, a computer program according to another aspect of the present disclosure is a computer program stored on a computer-readable medium for executing a series of steps of the automatic PQC migration execution method described above in a computer. The computer program may be a computer program including a high-level language code executable in a computer using an interpreter or the like, as well as a computer program including a machine language code generated by a compiler. In this case, the computer is not limited to a personal computer (PC) or a laptop computer and includes any information processing device such as a server, a smartphone, a tablet PC, a PDA, a mobile phone, or the like, which is equipped with a central processing unit (CPU) and is able to execute a computer program.

In addition, the computer-readable medium may continuously store a program executable by a computer or temporarily store it for execution or downloading. In addition, the medium may be various recording means or storage means in the form of a single type of hardware or a combination of multiple types of hardware, and may be distributed on a network without being limited to a medium directly connected to a computer system. Therefore, the detailed description above should not be interpreted as restrictive in all respects and should be considered as examples. The scope of the present disclosure should be determined by a reasonable interpretation of the attached claims, and all changes within the equivalent scope of the present disclosure are included in the scope of the present disclosure.

In addition, FIG. 11 illustrates a device 50 to which the proposed method of the present disclosure may be applied.

Referring to FIG. 11, the device 50 may be configured to implement an automatic PQC migration execution process for an application in a PQC migration system 100 according to the proposed method of the present disclosure. For example, the device 50 may be a PQC migration server 130.

For example, the device 50 to which the proposed method of the present disclosure may be applied may include network devices such as repeaters, hubs, bridges, switches, routers, gateways, or the like, computer devices such as desktop computers, workstations, or the like, mobile terminals such as smartphones or the like, portable devices such as laptop computers or the like, home appliances such as digital TVs or the like, and transportation devices such as automobiles or the like. As another example, the device 50 to which the present disclosure may be applied may be included as part of an ASIC (application specific integrated circuit) implemented in the form of a SoC (system-on-chip).

The memory 20 may be connected to the processor 10 during operation, may store programs and/or instructions for processing and controlling the processor 10, and may store data and information used in the present disclosure, control information required for processing data and information according to the present disclosure, temporary data generated during the data and information processing, or the like. The memory 20 may be implemented as a storage device such as a ROM (read-only memory), a RAM (random access memory), an EPROM (erasable programmable read-only memory), an EEPROM (electrically erasable programmable read-only memory), a flash memory, a SRAM (static ram), an HDD (hard disk drive), an SSD (solid state drive), or the like.

The processor 10 may be operatively connected to the memory 20 and/or the network interface 30, and controls the operation of each module in the device 50. In particular, the processor 10 may perform various control functions for performing the proposed method of the present disclosure. The processor 10 may also be called a controller, a microcontroller, a microprocessor, a microcomputer, or the like. The proposed method of the present disclosure may be implemented by hardware, firmware, software, or a combination thereof. In the case of implementing the present disclosure using hardware, an ASIC (application specific integrated circuit), a DSP (digital signal processor), a DSPD (digital signal processing device), a PLD (programmable logic device), an FPGA (field programmable gate array), or the like configured to perform the present disclosure may be provide in the processor 10. Meanwhile, when implementing the proposed method of the present disclosure using firmware or software, the firmware or software may include instructions related to modules, procedures, or functions of executing functions or operations necessary for implementing the proposed method of the present disclosure, and the instructions may be stored in the memory 20 or stored in a computer-readable recording medium (not shown) separately from the memory 20 and may be configured to cause, when executed by the processor 10, the device 50 to implement the proposed method of the present disclosure.

In addition, the device 50 may include a network interface device 30. The network interface device 30 is connected to the processor 10 during operation, and the processor 10 may control the network interface device 30 to transmit or receive wireless/wired signals that carry information and/or data, signals, messages, or the like through a wireless/wired network. The network interface device 30 may support various communication standards, such as, IEEE 802 series, 3GPP LTE(-A), 3GPP 5G, or the like, and may transmit and receive control information and/or data signals according to the corresponding communication standards. The network interface device 30 may be implemented outside the device 50 as needed.

Accordingly, in the method, device, system, and computer program for automatically performing PQC migration on an application according to an embodiment of the present disclosure, it is possible to efficiently respond to quantum vulnerability risks for various applications while minimizing required resources, and to effectively prevent quantum vulnerability in applications that may be caused by operator errors.

The above embodiments and drawings described in this specification are merely exemplary and do not limit the scope of the present disclosure in any way. In addition, the lines or connections between the components depicted in the drawings are merely exemplary of functional connections and/or physical or circuit connections, and may be replaced in an actual device or represented as additional and various functional connections, physical connections, or circuit connections. In addition, if there is no specific mention such as “essential”, “important”, or the like, the component thereof may not be absolutely necessary for the application of the present disclosure.

The use of the term “above” and similar terms in the specification of the present disclosure (especially in the claims) may correspond to both singular and plural components. In addition, a range described in the present disclosure includes an invention applied with respective values belonging to the range (unless otherwise stated), and is regarded as describing the respective values constituting the range in the detailed description of the invention. In addition, the steps presented in the method of the present disclosure are not necessarily intended to be bound by the sequence, and the sequence may be appropriately changed as needed, unless a certain step must necessarily precede according to the characteristics of each process. All examples or exemplary terms (for example or the like) in the present disclosure are merely intended to described the present disclosure in more detail, and the scope of the present disclosure is not limited to the examples or exemplary terms unless limited by the claims. In addition, those skilled in the art will understand that various modifications, combinations, and changes may be derived depending on design conditions and elements within the scope of the appended claims or their equivalents.

What is claimed is:

1. A method for automatically performing PQC migration on an application using a computing device, the method comprising:
determining whether or not a first application has quantum vulnerability on the basis of information about the first application, which is collected from an application distribution server configured to distribute source code of an application;
modifying one or more of source code, settings, or environment variables for the first application, based on a result of the determination, by the application distribution server; and
generating an execution file for the first application by reflecting the modified source code, settings, or environment variables.

2. The method according to claim 1, wherein the determining comprises determining whether or not the first application has quantum vulnerability using a predefined rule set, on the basis of version information of the first application.

3. The method according to claim 2, wherein the determining comprises, in a case where the rule set does not include information on quantum vulnerability corresponding to the version information of the first application, determining whether or not the first application has quantum vulnerability using the source code of the first application.

4. The method according to claim 3, comprising updating the rule set on the basis of a result of determining whether or not the first application has quantum vulnerability using the source code of the first application.

5. The method according to claim 2, wherein the modifying comprises:
producing a first post-quantum cryptography library corresponding to the version information of the first application using the rule set; and
modifying one or more of the source code, settings, or environment variables for the first application such that a cryptographic algorithm of the first post-quantum cryptography library is further reflected in addition to a cryptographic algorithm currently being used in the first application.

6. The method according to claim 1, wherein the generating comprises generating a docker container image to be executed on the basis of a cloud for the first application.

7. The method according to claim 6, wherein the modifying comprises modifying a docker file for the first application on the basis of the modified source code, settings, or environment variables.

8. The method according to claim 1, wherein the computing device is configured to perform PQC migration on the first application that is produced or updated and distributed by a third party.

9. A server comprising a processor and a memory, and configured to automatically perform PQC migration on an application,
wherein the memory comprises instructions configured to cause, when executed by the processor, the server to implement specific operations, and
wherein the specific operations comprises:
determining whether or not a first application has quantum vulnerability on the basis of information about the first application, which is collected from an application distribution server configured to distribute source code of an application;
modifying one or more of source code, settings, or environment variables for the first application, based on a result of the determination, by the application distribution server; and
generating an execution file for the first application by reflecting the modified source code, settings, or environment variables.

10. The server according to claim 9, wherein the determining comprises determining whether or not the first application has quantum vulnerability using a predefined rule set on the basis of version information of the first application.

11. The server according to claim 10, wherein the determining comprises, in a case where the rule set does not include information on quantum vulnerability corresponding to the version information of the first application, determining whether or not the first application has quantum vulnerability using the source code of the first application.

12. The server according to claim 11, wherein the rule set is updated on the basis of a result of determining whether or not the first application has quantum vulnerability using the source code of the first application.

13. The server according to claim 10, wherein the modifying comprises:
producing a first post-quantum cryptography library corresponding to the version information of the first application using the rule set; and
modifying one or more of the source code, settings, or environment variables for the first application such that a cryptographic algorithm of the first post-quantum cryptography library is further reflected in addition to a cryptographic algorithm currently being used in the first application.

14. The server according to claim 9, wherein the generating comprises generating a docker container image to be executed on the basis of a cloud for the first application.

15. The server according to claim 14, wherein the modifying comprises modifying a docker file for the first application on the basis of the modified source code, settings, or environment variables.

16. The server according to claim 9, wherein the server is configured to perform PQC migration on the first application that is produced or updated and distributed by a third party.

17. A computer-readable storage medium storing instructions configured to cause, when executed by a processor, a server, which comprises the processor and is configured to automatically perform PQC migration on an application, to implement specific operations,
wherein the specific operations comprises:
determining whether or not a first application has quantum vulnerability on the basis of information about the first application, which is collected from an application distribution server configured to distribute source code of an application;
modifying one or more of source code, settings, or environment variables for the first application, based on a result of the determination, by the application distribution server; and
generating an execution file for the first application by reflecting the modified source code, settings, or environment variables.
